(19) United States
(12) Patent Application Publication
(10) Pub. No.: US 2014/0028430 A1
(43) Pub. Date: Jan. 30, 2014

(54) MULTILAYER INDUCTOR AND PROTECTING LAYER COMPOSITION FOR MULTILAYER INDUCTOR

(71) Applicant: SAMSUNG ELECTRO-MECHANICS CO., LTD, Suwon-si (KR)

(72) Inventors: Sang Moon LEE, Suwon-si (KR); Young Seuck YOO, Suwon-si (KR); Jeong Bok KWAK, Suwon-si (KR); Yong Suk KIM, Suwon-si (KR); Young Do KWEON, Suwon-si (KR); Sung Kwon WI, Suwon-si (KR)

(73) Assignee: SAMSUNG ELECTRO-MECHANICS CO., LTD, Suwon-si (KR)

(21) Appl. No.: 13/831,204

(22) Filed: Mar. 14, 2013

(30) Foreign Application Priority Data
Jul. 25, 2012 (KR) 10-2012-0081270

(51) Int. Cl. H01F 27/00

(52) U.S. Cl. CPC H01F 27/00
USPC 336/200; 523/400; 523/468; 523/466; 523/458

(57) ABSTRACT

Disclosed herein are a multilayer inductor including a protecting layer including an inorganic filler having different stretching ratios in traverse and mechanical directions or an inorganic filler coated with a color former, and a protecting layer composition of a multilayer inductor, including 10 to 30 parts by weight of an inorganic filler having different stretching ratios in traverse and mechanical directions, and 10 to 30 parts by weight of a dispersant, based on 100 parts by weight of an epoxy resin, so that thermal deformation of an inductor chip can be reduced by including the inorganic filler having different stretching ratios in traverse and machine directions in the outermost insulating layer of the multilayer inductor, thereby reducing change in external appearance due to heat, thereby providing a multilayer inductor securing reliability.

### CROSS REFERENCE(S) TO RELATED APPLICATIONS

This application claims the benefit under 35 U.S.C. Section 119 of Korean Patent Application Serial No. 10-2012-0081270, entitled “Multilayer Inductor and Protecting Layer Composition for Multilayer Inductor” filed on Jul. 25, 2012, which is hereby incorporated by reference in its entirety into this application.

### BACKGROUND OF THE INVENTION

1. Technical Field

The present invention relates to a multilayer inductor and a protecting layer composition for the multilayer inductor.

2. Description of the Related Art

As mobile devices have smaller sizes and more complex functions, electronic parts are requested to have ultra small sizes. Particularly, high-frequency parts and various kinds of parts used in RF blocks are requested to have smaller sizes and higher precision.

In order to cope with miniaturization and high-frequency of the mobile device and the RF module or the like, the inductance is requested to have high precision and high Q characteristics.

In the multilayer inductor according to the related art, process reliability of the inductor is secured by coating coil patterns 20 on a ceramic insulating layer 10, connecting and laminating the coil patterns through interlayer vias (not shown) to thereby construct a laminate, forming an insulating layer 30 using a polymer resin in an empty space among the coil patterns and pressing and sintering this, printing external electrodes 40 to thereby form final electrodes, and then applying a protecting layer 50, using a polymer resin as a filler, at the outermost portion thereof.

In the related art, the protecting layer 50 has been used by mixing inorganic filler materials such as silica and the like together with the polymer resin.

However, the electrodes may be spread during the printing process, or the coil may be easily deformed since alignment is warped and the electrodes are pressed in the laminating and pressing processes. The coil may be more severely deformed due to shrinkage deformation at the time of sintering. In addition, a transparent epoxy resin is generally used as the polymer resin of the protecting layer formed at the outermost portion of the electrode. In the case where the polymer resin is used as a filler, when thermal impact is applied to an inductor chip, an external appearance of the inductor chip may be distorted due to thermal expansion characteristics of the polymer resin.

For this reason, it is difficult to control the inductance value of the inductor and realize a low direct current resistance, and thus, high-Q characteristics requested in the high-frequency inductor is difficult to secure.

### RELATED ART DOCUMENTS

### Patent Documents

(Patent Document 1) Japanese Patent Laid-Open Publication No. 2003-142832

### SUMMARY OF THE INVENTION

An object of the present invention is to provide a multilayer inductor, capable of solving the problem that an inductor chip is deformed due to thermal expansion of the polymer resin according to the related art, in forming a protecting layer by using a polymer resin after forming electrodes.

Another object of the present invention is to provide a multilayer inductor, capable of securing the process reliability when an electrode exposing process is performed by using a transparent epoxy resin.

Still another object of the present invention is to provide a protecting layer composition of the multilayer inductor.

According to an exemplary embodiment of the present invention, there is provided a multilayer inductor, including a protecting layer including an inorganic filler having different stretching ratios in traverse and machine directions.

The inorganic filler may have an aspect ratio of 20˜200.

The inorganic filler may have a specific gravity of 1.5˜3.5.

The inorganic filler may be at least one selected from the group consisting of a glass fiber, a carbon fiber, wallastonite, whisker, and a stainless steel fiber.

The inorganic filler may have a shape of at least one selected from the group consisting of a rod shape, a flat shape, a spherical shape, a flake shape, and a cylindrical shape.

The protecting layer may further include a polymer resin.

The polymer resin may be an epoxy resin.

According to another exemplary embodiment of the present invention, there is provided a multilayer inductor including a protecting layer including an inorganic filler coated with a color former.

The inorganic filler may have an aspect ratio of 20˜200 and have different stretching ratios in traverse and machine directions.

The inorganic filler may have a specific gravity of 1.5 to 3.5.

The inorganic filler may be at least one selected from the group consisting of a glass fiber, a carbon fiber, wallastonite, whisker, and a stainless steel fiber.

The color former may be an inorganic or organic dye.

The protecting layer may further include a polymer resin.

The polymer resin may be an epoxy resin.

According to still another exemplary embodiment of the present invention, there is provided a protecting layer composition for a multilayer inductor, the protecting layer composition including 10 to 30 parts by weight of an inorganic having different stretching ratios in traverse and machine directions and 10 to 30 parts by weight of a dispersant, based on 100 parts by weight of an epoxy resin.

The inorganic filler may have an aspect ratio of 20˜200.

The inorganic filler may have a specific gravity of 1.5 to 3.5.

The inorganic filler may be at least one selected from the group consisting of a glass fiber, a carbon fiber, wallastonite, whisker, and a stainless steel fiber.

The inorganic filler may have a shape of at least one selected from the group consisting of a rod shape, a flat shape, a spherical shape, a flake shape, and a cylindrical shape.

As the dispersant, a titanium based dispersant may be used.

### BRIEF DESCRIPTION OF THE DRAWINGS

FIG. 1 shows a structure of a multilayer inductor of the related art;

FIG. 2 shows a structure of a multilayer inductor including an inorganic filler according to an exemplary embodiment of the present invention;

FIG. 3 shows a structure of the inorganic filler according to the present invention;

FIGS. 4A to 4I show a process for manufacturing the multilayer inductor according to the exemplary embodiment of the present invention; and

FIGS. 5 and 6 show coefficients of thermal expansion (CTE) of protecting layer compositions in multilayer inductors manufactured according to Comparative Example 1 and Example 1, respectively.

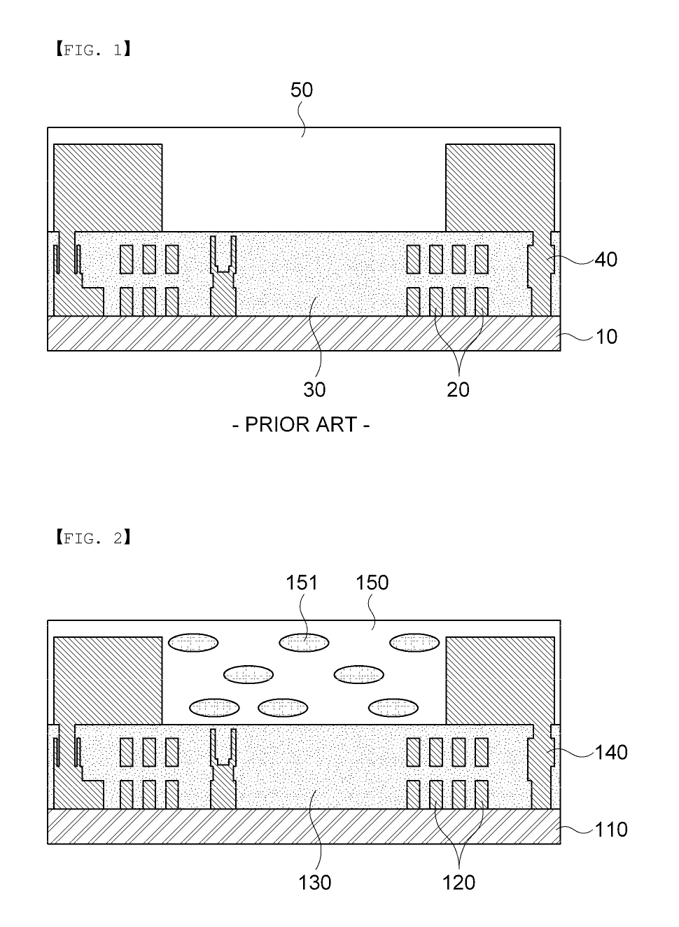

### DESCRIPTION OF THE PREFERRED EMBODIMENTS

Hereinafter, the present invention will be described in more detail with reference to the accompanying drawings.

Terms used in the present specification are for explaining the embodiments rather than limiting the present invention. As used herein, unless explicitly described to the contrary, a singular form includes a plural form in the present specification. Also, used herein, the word “comprise” and/or “comprising” will be understood to imply the inclusion of stated constituents, steps, operations and/or elements but not the exclusion of any other constituents, steps, operations and/or elements.

The present invention provides a multilayer inductor, capable of reducing thermal deformation and enhancing strength by not using a magnetic material as a protecting layer thereof used in a noise filter or the like but filling a polymer resin and an inorganic filter, and a protecting layer composition for the multilayer inductor.

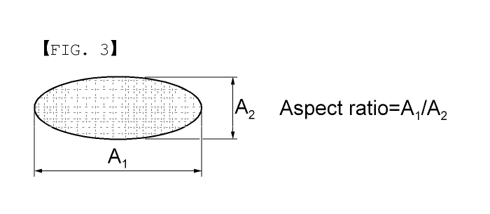

FIG. 2 shows a structure of a multilayer inductor according to an exemplary embodiment of the present invention. Referring to FIG. 2, a multilayer inductor may include a plurality of insulating layers 130 constituting a laminate formed on a substrate 110, internal electrode coils 120 formed in the plurality of insulating layers 130, external electrode terminals 140 connected to ends of the internal electrode coils 120, and a protecting layer 150 formed on a surface of the laminate.

Conventionally, the protecting layer 150 is formed by a complex layer composed of an epoxy resin and a ferrite. In the case where the protecting layer 150 is formed of a polymer resin such as the epoxy resin, when thermal impact is applied to an inductor chip, an external appearance of the inductor chip may be distorted due to thermal expansion characteristics of the polymer resin. Particularly, in the case of the epoxy resin, thermal deformation in a traverse direction is severe, and thus external appearance defects of this chip are particularly worse.

Therefore, the present invention can solve the above problem, by including an inorganic filler 151, which satisfies a specific aspect ratio and of which a stretching ratio in a traverse direction is a stretching ratio in a machine direction, in the protecting layer of the multilayer inductor.

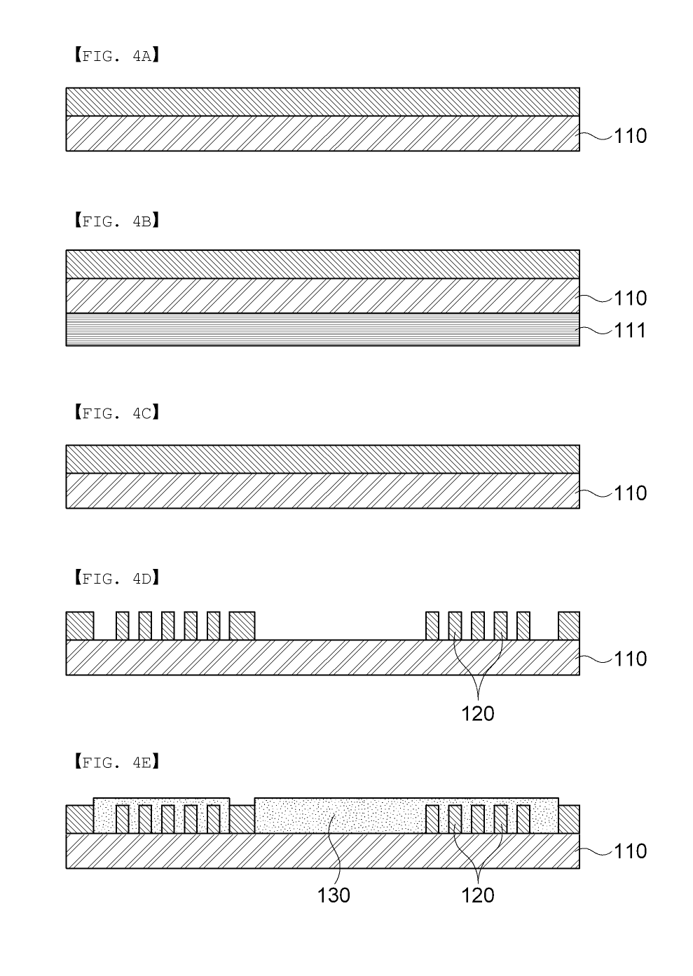

Preferably, the inorganic filler according to the present invention may have an aspect ratio of 20˜200 as shown in FIG. 3. If the aspect ratio of the inorganic filler according to the present invention is below 20, the morphology anisotropy characteristic thereof is not sufficient. If the aspect ratio thereof is above 200, the filler arrangement for maximizing the morphology anisotropy characteristic may be problematic.

In the inorganic filler according to the present invention, the stretching ratio in the traverse direction is different from the stretching ratio in the machine direction, resulting in strong directivity, and thus, the effect of suppressing shrinkage and expansion in a flow direction is excellent, and particularly, the effect in the traverse direction is superior to that in the machine direction.

In addition, the inorganic filler according to the present invention has a specific gravity of 1.5˜3.5, which is larger than that of the polymer resin used. Therefore, at the time of preparing the protecting layer composition, such the inorganic filler has a predetermined orientation in the protecting layer 150 as shown in FIG. 2 in an injection process thereof, and thus, has an effect of minimizing deformation of the multilayer inductor due to external heat impact.

Such the inorganic filler may be at least one selected from the group consisting of a glass fiber, a carbon fiber, wallastonite, whisker, and a stainless steel fiber. The inorganic filler according to the preferred embodiment of the present invention may have a shape of at least one selected from a rod shape, a flat shape, a spherical shape, a flake shape, and a cylindrical shape.

In addition, according to the preferred embodiment of the present invention, a dye such as a color former may be used as the inorganic filler, and the inorganic filler may be used in a coating manner. In the related art, since the epoxy resin is transparent, it is difficult to accurately control the time when the internal electrode coil is exposed by etching the epoxy resin during the electrode exposing process. Therefore, in the present invention, the inorganic filler is coated with a color former or the like, and thus, the epoxy resin and the electrode are easily differentiated from each other, thereby simply determining the time when the electrode is exposed at the time of etching, skipping a dye dispersing process to thereby simplify the process, and improving the electrode exposure reliability.

Examples of the color former may be an inorganic dye, an organic dye, and the like, and kinds of the inorganic and organic dyes are not particularly limited as long as they are coated on a surface of the inorganic filler to thereby exhibit color.

In addition, the protecting layer of the present invention may be formed by using the polymer resin mixed with the inorganic filler. According to the preferred embodiment of the present invention, an epoxy resin may be preferably used as the polymer resin, but the present invention is not limited thereto. A polyimide resin, a polyamide resin, a polyaniline resin, or the like may be used.

In addition, the protecting layer 150 according to the present invention may be formed of an appropriate dispersant in order to improve dispersibility, in addition to the polymer resin and the inorganic filler. The kind of dispersant is not particularly limited, but a titanium based dispersant may be used.

The protecting layer composition according to the present invention may include 10 to 50 parts by weight of an inorganic filler having different stretching ratios in traverse and machine directions, and 0.1˜1 part by weight of a dispersant, based on 100 parts by weight of the epoxy resin.

If the content of the inorganic filler is below 10 parts by weight, the control of stretching ratios is problematic. If the content thereof is above 50 parts by weight, dispersibility and flowability are reduced, and thus, processability is problematic.

In addition, if the content of the dispersant is below 0.1 parts by weight, dispersibility may be degraded. If the content thereof is above 1 part by weight, electric characteristics may be deteriorated.

The protecting layer composition according to the present invention may be preferably prepared by mixing the epoxy resin, the inorganic filler, and the dispersant, uniformly mixing them for 30˜90 minutes, performing a defoaming process for 10˜60 minutes, and then performing repeated dispersion by using a 3-roll mill.

In addition, the protecting layer composition according to the present invention may include a hardener for hardening the epoxy resin, a hardening promoter, and other additives within general ranges thereof, as long as the protecting layer composition does not damage physical properties of the multilayer inductor according to the present invention.

In addition, a general ferrite substrate may be used as the substrate 110 of the multilayer inductor of the present invention. The material of the ferrite is not particularly limited.

A plurality of insulating layers 130 are laminated on the ferrite substrate 110 to thereby constitute a laminate. Internal electrode coils 120 are formed in the respective insulating layers 130. The internal electrode coils 120 in the respective insulating layers 130 are connected to each other by neighboring via electrodes (not shown).

The insulating layer 130 serves to insulate the respective internal electrode coils 120 from each other and secure flatness of the surface in which the internal electrode coils 120 are formed. A polymer resin having excellent electric and magnetic insulating characteristics and good processability may be preferably used as a material for the insulating layer 130. Examples thereof may be an epoxy resin, a polyimide resin, and the like, but the present invention is not particularly limited thereto.

In addition, the internal electrode coils 120 formed in the respective insulating layers 13 may be formed by using copper (Cu), aluminum (Al), or the like, having excellent conductivity and processability. The internal electrode coils 120 may be formed by using an etching method using photolithography or an additive method (plating method), but the method thereof is not particularly limited.

An opening portion is formed inside of the respective internal electrode coils 120, which corresponds to centers of the respective insulating layers 130 while the opening portion penetrates the insulating layers 130. The internal electrode coils 120 formed in the respective insulating layers 130 are electrically connected to each other by via electrodes in respective layers.

In addition, respective ends of each of the internal electrode coils 120 are connected to the external electrode terminals 140. Generally, four external electrode terminals 140 are formed at both lateral surfaces in an outer periphery surface of the laminate.

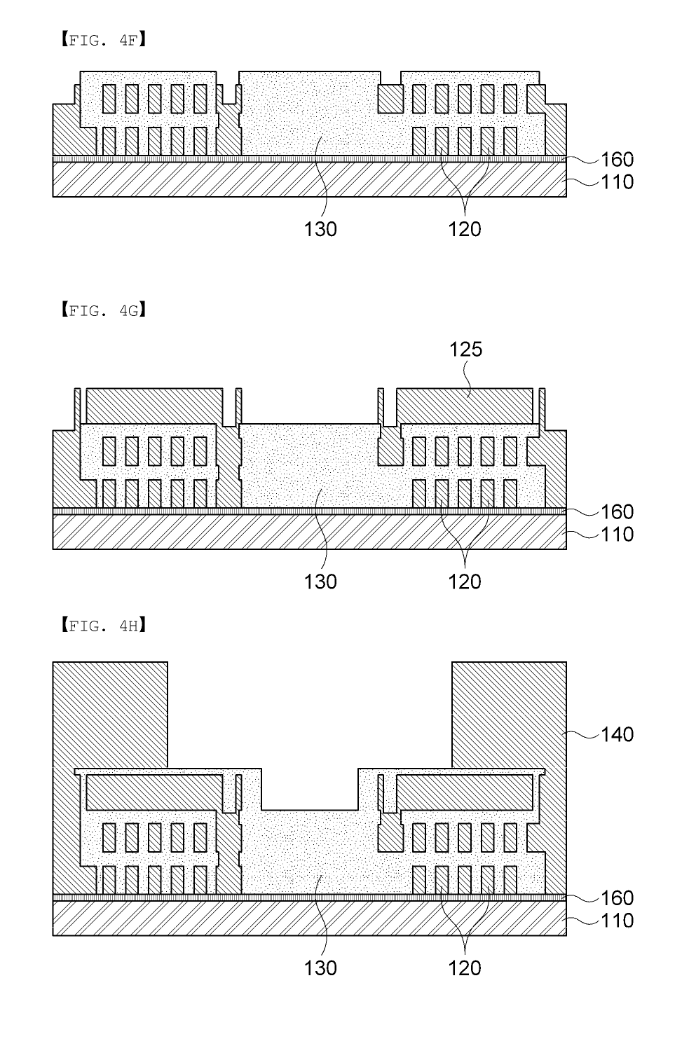

A procedure for manufacturing the multilayer inductor according to the present invention will be described with reference to FIGS. 4A to 41. First, a support 111 is attached to an insulating substrate 110, and then etched. An internal electrode coil 120 is formed on the etched insulating substrate 110 by using copper plating. A first insulating layer 130 is formed on the internal electrode coil 120.

In addition, an internal electrode coil is formed on the first insulating layer by copper plating, and then a second insulating layer is formed on the internal electrode coil. The internal electrode coils formed in the respective insulating layers are electrically connected to each other through via electrodes.

A polymer insulating layer 160 may be provided for insulation between the insulating substrate 110 and the internal electrode coils 120.

Outer periphery terminals of the internal electrode coils are subjected to a lead out process to thereby be connected to the external electrode terminals 140 through outflow terminals. Then, again, the internal electrode coils in the second insulating layer and the third insulating layer are electrically connected to each other through via electrodes, and then the internal electrode coils formed in the respective insulating layers are connected to the external electrode terminals. In addition, a protecting layer 150 is formed on the outermost insulating layer.

In the present invention, the protecting layer may be formed by mixing a polymer resin and an inorganic filler having different stretching ratios in traverse and machine directions. The thickness of the protecting layer may be 50˜100 μm, which is preferable in view of wetting property and defoaming property.

Hereinafter, examples of the present invention will be described in detail. The following examples are only for illustrating the present invention, and the scope of the present invention should not be construed as being limited by this examples. In addition, specific compounds are used in the following examples, but it is obvious to those skilled in the art that equivalents thereof can exhibit the same or similar degrees of effects.

### EXAMPLE 1

A multilayer inductor was manufactured following FIGS. 4A to 4I. A first insulating layer of an epoxy resin was formed an insulating film made of a ferrite substrate, and an internal electrode coil was formed on the first insulating layer by using a copper (Cu) metal. In addition, an internal electrode coil was formed on a second insulating layer made of an epoxy resin by using a copper (Cu) metal. The process of forming an internal electrode coil on each insulating layer may be repeatedly performed, to thereby form further insulating layers. In addition, the internal electrode coils formed in the first and second insulating layers were electrically connected to each other through via electrodes. Outer periphery terminals of the internal electrode coils were connected to external electrode terminals through outflow terminals. Again, the internal electrode coils of the second insulating layer and the third insulating layer were electrically connected to each other through via electrodes. Then the internal electrode coils formed in the respective insulating layers were connected to the external electrode terminals.

In addition, a protecting layer having a thickness of 100 μm was formed on the outermost insulating layer. A protecting layer composition was prepared by mixing an epoxy resin (YD-172X75), a glass fiber having different stretching ratios in traverse and machine directions and an aspect ratio of 50 and a specific gravity of 2.6, as an inorganic filler, a hardener (GX-475B70S), and a dispersant (BYK-2155). The protecting layer composition included 20 parts by weight of the inorganic filler and 20 parts by weight of the dispersant, based on 100 parts by weight of the epoxy resin.

The above composition was mixed for 60 minutes by using a mixer, followed by defoaming for 30 minutes, and dispersed by using a 3-roll mill five times.

### COMPARATIVE EXAMPLE 1

A multilayer inductor was manufactured by the same method as Example 1, except that the protecting layer was formed by using a composition using an epoxy resin but not containing an inorganic filler.

### EXPERIMENTAL EXAMPLE 1

As for the multilayer inductor according to Example 1 manufactured by using a protecting layer composition containing an inorganic filler of the present invention, the resistance (Rdc), inductance (L), Qₘₐₓ, and self-resonance frequency (SRF) thereof were measured, and the measurement results were tabulated in Table 1. The higher Qₘₐₓ leads to an ideal inductor and means that the loss is less.

TABLE 1

| Sample | | | | |
|---|---|---|---|---|
| No | Rdc (Ω) | L (@100 MHz) | Qₘₐₓ | SRF |
| 1 | 0.302 | 6.04 nH | 30.3 | 6.03 GHz |
| 2 | | 6.04 nH | 31.0 | 6.17 GHz |

As shown in the results of Table 1 above, it was confirmed that the multilayer inductor of the present invention including the protecting layer formed by using the composition including the inorganic filler having different stretching ratios in traverse and machine directions had excellent reliability in humidity resistance and high load.

### EXPERIMENTAL EXAMPLE 2

### Verification on Coefficient of Thermal Expansion

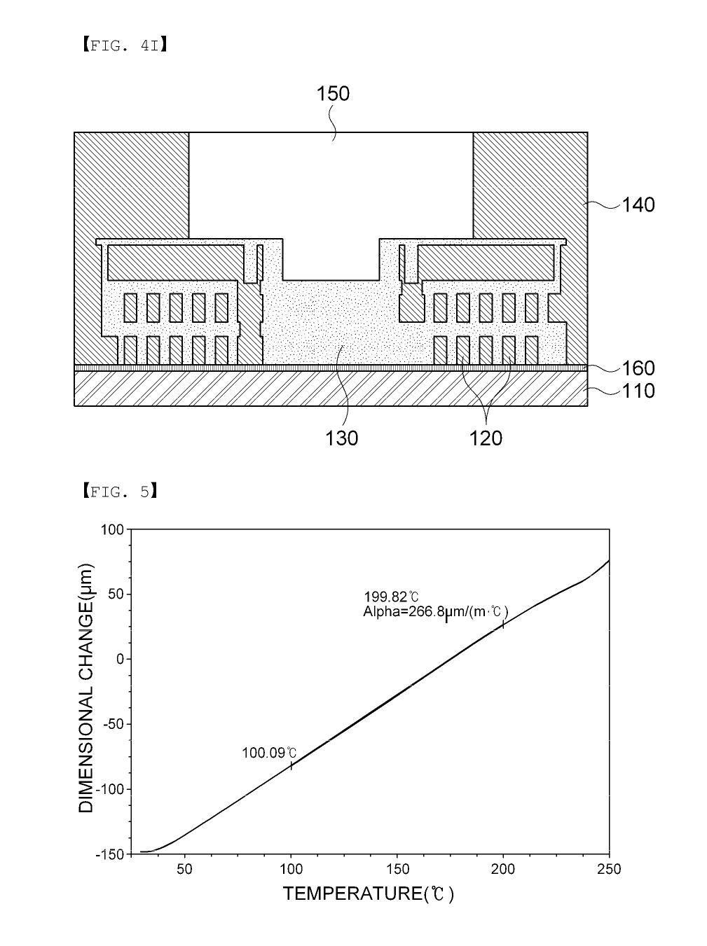

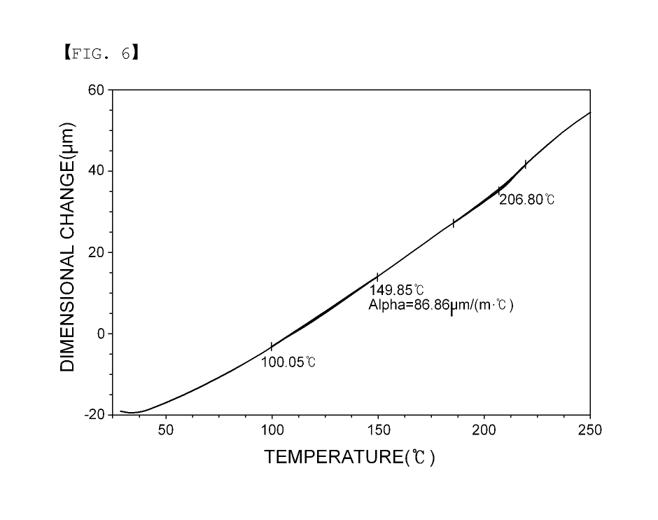

Coefficients of thermal expansion (CTEs) of the protecting layer compositions for the multilayer inductors manufactured according to Comparative Example 1 and Example 1 were measured, and the measurement results are shown in FIGS. 5 and 6, respectively.

FIG. 5 shows the measured coefficient of thermal expansion (CTE) of the epoxy resin not containing an inorganic filler, and CTE of the epoxy resin was measured 266.8 μm/(m·° C.).

However, it was confirmed that, in the case of the composition where the inorganic filler having different stretching ratios in traverse and machine directions is dispersed in the epoxy resin, the CTE value thereof was 86.86 μm/(m·° C.), and the CTE value thereof was significantly reduced after dispersion of the inorganic filler.

These results confirmed that the inorganic filler according to the present invention has a predetermined orientation in the protecting layer since the stretching ratio in the traverse direction is different from the stretching ratio in the machine direction, so that deformation due to external heat impact can be minimized when the inorganic filler is used for the protecting layer of the multilayer inductor.

### EXAMPLE 2

A multilayer inductor was manufactured by the same method as Example 1, except that a glass fiber (specific gravity: 2.6, aspect ratio: 100) surface-coated with a phthalocyanine based dye as a color former for an inorganic filler.

### EXPERIMENTAL EXAMPLE 3

### Verification on Electrode Exposure Reliability

The reliability was verified by forming a protecting layer using a protecting layer composition prepared according to Example 2 and removing an overcoated polymer by a polishing process to expose electrodes to the outside.

As the results, it was seen that, the thickness of the external electrode was 85˜100 μm after the polishing process from 90˜110 μm before the polishing process, and thus the effect of decreasing the thickness of the electrode due to polishing was significantly reduced.

As set forth above, according to the present invention, thermal deformation of the inductor chip can be reduced by including an inorganic filler having different stretching ratios in traverse and machine directions in the outermost insulating layer of the multilayer inductor, thereby reducing change in external appearance due to heat, so that a multilayer inductor securing reliability can be provided.

Further, the electrode exposure reliability can be improved, and a dye dispersing process is removed to thereby simplifying the process, by including an inorganic filler, which has different stretching ratios in traverse and machine directions and is coated with a color former, in the outermost insulating layer of the multilayer inductor.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A multilayer inductor, comprising a protecting layer including an inorganic filler having different stretching ratios in traverse and machine directions.

2. The multilayer inductor according to claim 1, wherein the inorganic filler has an aspect ratio of 20˜200.

3. The multilayer inductor according to claim 1, wherein the inorganic filler has a specific gravity of 1.5˜3.5.

4. The multilayer inductor according to claim 1, wherein the inorganic filler is at least one selected from the group consisting of a glass fiber, a carbon fiber, wallastonite, whisker, and a stainless steel fiber.

5. The multilayer inductor according to claim 1, wherein the inorganic filler has a shape of at least one selected from the group consisting of a rod shape, a flat shape, a spherical shape, a flake shape, and a cylindrical shape.

6. The multilayer inductor according to claim 1, wherein the protecting layer further includes a polymer resin.

7. The multilayer inductor according to claim 6, wherein the polymer resin is an epoxy resin.

8. A multilayer inductor comprising a protecting layer including an inorganic filler coated with a color former.

9. The multilayer inductor according to claim 8, wherein the inorganic filler has an aspect ratio of 20˜200 and has different stretching ratios in traverse and machine directions.

10. The multilayer inductor according to claim 8, wherein the inorganic filler has a specific gravity of 1.5 to 3.5.

11. The multilayer inductor according to claim 8, wherein the inorganic filler is at least one selected from the group consisting of a glass fiber, a carbon fiber, wallastonite, whisker, and a stainless steel fiber.

12. The multilayer inductor according to claim 8, wherein the color former is an inorganic or organic dye.

13. The multilayer inductor according to claim 8, wherein the protecting layer further includes a polymer resin.

14. The multilayer inductor according to claim 13, wherein the polymer resin is an epoxy resin.

15. A protecting layer composition for a multilayer inductor, the protecting layer composition comprising 10 to 30 parts by weight of an inorganic having different stretching ratios in traverse and machine directions and 10 to 30 parts by weight of a dispersant, based on 100 parts by weight of an epoxy resin.

16. The protecting layer composition according to claim 15, wherein the inorganic filler has an aspect ratio of 20˜200.

17. The protecting layer composition according to claim 15, wherein the inorganic filler has a specific gravity of 1.5 to 3.5.

18. The protecting layer composition according to claim 15, wherein the inorganic filler is at least one selected from the group consisting of a glass fiber, a carbon fiber, wallastonite, whisker, and a stainless steel fiber.

19. The protecting layer composition according to claim 15, wherein the inorganic filler has a shape of at least one selected from the group consisting of a rod shape, a flat shape, a spherical shape, a flake shape, and a cylindrical shape.
